(19) United States
(12) Patent Application Publication
(10) Pub. No.: US 2003/0055945 A1
(43) Pub. Date: Mar. 20, 2003

(54) Language and interface for unified network service creation, provision and deployment

(75) Inventors: Charles Bear, Arlington, MA (US); Prasad Dorbala, Lexington, MA (US); Sunil K. Kotagiri, Lowell, MA (US); Srinivas Loke, Westford, MA (US); Vikram Saksena, Acton, MA (US); Ravi S. Kumar, Shrewsbury, MA (US); Satish L. Yellanki, Lowell, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Narad Networks, Inc., Westford, MA (US)

(21) Appl. No.: 10/247,804

(22) Filed: Sep. 19, 2002

Related U.S. Application Data
(63) Continuation-in-part of application No. 10/143,728, filed on May 8, 2002.
(60) Provisional application No. 60/289,617, filed on May 8, 2001.

(51) Int. Cl. G06F 15/173

(52) U.S. Cl. 709/223; 717/114

(57) ABSTRACT

A services definition language for seamlessly creating and maintaining services over a network service reduces deployment time, cost, and maintenance, and increases reliability. An executable element generator is operable to process module scripts, such as an XML (Extensible Markup Language) script, recognized across the execution environment. Each module script describes a network element, service, or subscription. A plurality of available services are defined, in which each of the available services corresponds to one or more of the module scripts. A script processor interprets the module script and provides it to executable element generators conversant in the script language, which process the module scripts via a GUI to produce executable objects. A service provisioning engine is operable to execute the executable objects for providing the corresponding service via the network.

### RELATED APPLICATIONS

This application is a continuation-in-part of Application No. 10/143,728, entitled “Extensible Service Provisioning Engine,” filed on May 8, 2002, Attorney's Docket No. 3070.1004-001, which claims the benefit of U.S. Provisional Application No. 60/289,617, filed on May 8, 2001, Attorney's Docket No. 3070.1004-000. The entire teachings of the above applications are incorporated herein by reference.

### NOTICE OF COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

In a network system, services are provided to users via network interconnections from a service provider. Such services include data, voice, video, and others, and are typically implemented and/or initiated via an interconnection from a network node operated by the service provider to customer premises equipment (CPE) operable to receive the service. Customer premises equipment may include, for example, PCs, TVs, wired and wireless phones, mass storage devices, or other network elements operable to be interconnected over the network. Service provisioning in this manner includes identifying the service to be provided, identifying the CPE, or network node, to receive the service, and determining the manner in which the service is to be delivered to the end-user.

One method of providing services to an end user includes so-called hybrid fiber coax (HFC) networks. Physically extending the network into the home of each user would be cumbersome, however many homes are already interconnected by coaxial cables employed for carrying legacy cable television signals. Such HFC networks employ a high speed networking device, such as an optical networking unit (ONU), at a point which is capable of accessing 500-1000 end user homes via the existing coax cable plant. Tapping into the tree-and-branch topology of the legacy coax network allows high speed ONUs to be installed only once for every 500-1000 homes, rather than in every home. This approach allows the high-speed optical network to be employed for much of the physical distance, and employs the existing legacy coax for the so-called “last mile” run to individual users. By employing frequencies on the coax typically above the frequency already employed for cable TV, HFC networks utilize unused bandwidth to overcome the “last mile” problem and provide services to users efficiently and economically.

Service provisioning, therefore, typically involves identifying a number of network nodes and instructions, for example machine instructions for configuring a particular hardware element, concerned with providing a particular service, and directing the nodes by transmitting appropriate instructions to which the nodes are responsive. In order for the service to be properly provisioned, concerned nodes must be accurately identified and the proper instructions transmitted accordingly. Often, however, there are many different types of nodes on such a network, each responsive to a different set of instructions. Further, each service typically requires a specific corresponding set of instructions to be transmitted. Still further, new services and new nodes are frequently added or upgraded, requiring additional instructions or modification of existing instructions, in order to provision the service.

In a typical prior art service provisioning system, multiple sets of instructions are maintained for each of the various services, and for each of the hardware types which may be invoked in providing the service. Each provision of the service requires identifying a set of the concerned instructions, often called an adaptor, and performing an aggregation, such as a compilation or interpretation, of the set of instructions concerned with the particular instantiation, thereby resulting in a specific build of the service. Frequently, multiple builds are maintained to correspond to different customer sites and different services which are to be provided to that site. However, maintaining multiple builds and multiple adaptors raises maintenance and development issues. Such adaptors are often written in a low level language specific to a particular platform. In a non-monolithic system, i.e. a system having many platforms, a different adaptor may be required for each supported platform. The need for multiple adaptors can result in increased deployment time and increased cost as custom adaptors and builds are deployed to adapt to new or upgraded services and hardware to be provisioned.

Attempts have been made to provide a common denominator to nodes which run on different platforms, or operating systems, each of which has a particular set of instructions to which it is responsive. The Extensible Markup Language (XML) is a generic syntax promoted by the World Wide Web Consortium (W3C, Massachusetts Institute of Technology, Laboratory for Computer Science, Cambridge, Mass.) intended to be recognized, interpreted, and executed across many platforms. While XML may prove useful toward deploying the same instantiation of a service across nodes of different platforms, custom adaptors must still be deployed when variables other than operating system platforms are introduced. Such variables include new hardware devices such as switches, routers and bridges, new CPE units, new revisions to existing services, and addition of new services altogether. Each of these occurrences requires a custom adaptor to be developed and employed to provision the service.

### SUMMARY OF THE INVENTION

In a network services delivery environment, service deployment time, cost and maintenance are reduced, and reliability increased, by a system for provisioning services over a network which includes an executable element generator operable to process module scripts recognized across an execution environment, and generate corresponding executable objects. A plurality of services are defined, in which each of the services corresponds to one or more of the module scripts. The services are provided via a network in communication with, and operable to provide the services to, each of a plurality of users. A service provisioning engine (SPE) is operable to execute the executable objects for providing the corresponding service via the network. The SPE reads the scripts and associated parameters from a common repository such as a knowledge base, and provides or initiates the service by transmitting information signals, via the network, to one or more customer premises equipment units, such as PCs, televisions, and telephones at the customers site.

The network as employed herein therefore defines an execution environment. Network elements such as hardware devices are deployed and interconnected by the network. The network elements are configured by configuration parameters for the particular network element. The configuration parameters coordinate the network element for a particular service, such as assigning ports and buffers within a device. Services such as voice, video, and data are defined and employ the network elements through manipulation of element parameters of the network elements concerned with providing the service, for example, bit rate or QOS (Quality of Service). Each of the services, further, is implemented by instantiations of service plans, each service plan enumerating service parameters for identifying variables and aspects associated with the particular instantiation of the service, such as price and duration.

Each of the executable element generators employed in the service provisioning system is operable to process executable scripts, such as an XML compliant file, for a particular network entity, such as network elements, services, and service plans. In a particular embodiment there are at least three types of executable element generators. A module builder is operable to define the configuration parameters corresponding to each of the network elements. A network pre-provisioning manager (NPP) is operable to define the element parameters corresponding to each of the services. A service creation manager (SCM) is operable to define service plans for deploying an instantiation of the service. Each of the executable element generators is preferably a graphical user interface (GUI) directed to seamlessly guiding an operator through computing an executable script which includes the desired parameters for the concerned network entity.

In another particular embodiment, another executable element generator is employed. A service provisioning manager (SPM) defines attributes corresponding to an instantiation, or subscription, of a service for a particular user. In this embodiment, the executable scripts are defined first as module scripts indicative of attributes concerning the element, service, or subscription. The executable element generators receive the module scripts via a script processor conversant in a service definition language, such as an XML compliant language, operable to allow the executable element generators to associate values with the attributes, or parameters, in the module script. The module scripts, once processed by the executable element generators, comprise executable scripts which are customized, or deployed by having values associated with attributes therein, and are stored in the knowledge base as executable objects. The executable objects need not necessarily conform to the service definition form of the module scripts, as they have been processed into form where it may be known and utilized by other applications in the network services operating system (NSOS).

The system further includes a knowledge base, which may be for example an LDAP (lightweight directory access protocol) directory, for storing the executable scripts and related parameters. The service provisioning engine accesses the knowledge base via an indicator, and provisions the service by reading the executable scripts and associated parameters, and deploying the service at the particular user's CPE via the network.

The network as defined herein includes an access network, a metro area network, and a wide area network. The service provisioning engine employs at least the access network in provisioning the service, the access network including a hybrid fiber-coax network which may also be employed for providing non-provisioned, or legacy, signals to a user.

In this manner, executable scripts, or module scripts, such as XML compliant files, are processed by the executable element generator, and recognized by the service provisioning engine. Further, since the scripts are XML compliant, they are capable of being recognized by each of the network elements with which the service provisioning engine communicates. The use of the executable element generators allows the executable scripts to be selectively regenerated on demand to correspond to changes in the network elements, services, or service plans, without redesigning or manually recoding adaptor routines to correspond to the new network elements, services, or service plans. In alternate embodiments, other forms of executable script files may be employed to accommodate various deployment and compatibility issues. The system therefore provides a rapidly customizable and configurable service provisioning implementation.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of the present invention;

FIG. 2 shows the local broadband access networks of FIG. 1;

FIG. 3 shows a block diagram of a service provisioning system;

FIG. 4 shows the service provisioning system of FIG. 3 in greater detail;

FIGS. 5a-5d show flowcharts of service provisioning as defined by the present invention;

FIG. 6 shows a data flow of module scripts employed in creating and provisioning services;

FIG. 7 shows a three tier model of the architecture of the network services operating system (NSOS);

FIG. 8 shows different layers within the NSOS responsive to the module scripts;

FIG. 9 shows multiple executable scripts invoked in provisioning service plans;

FIG. 10 shows a layer diagram of the execution environment employed by the present invention; and

FIG. 11 shows an example of processing of a code fragment of a module script of the present invention.

### DETAILED DESCRIPTION OF THE INVENTION

A description of preferred embodiments of the invention follows.

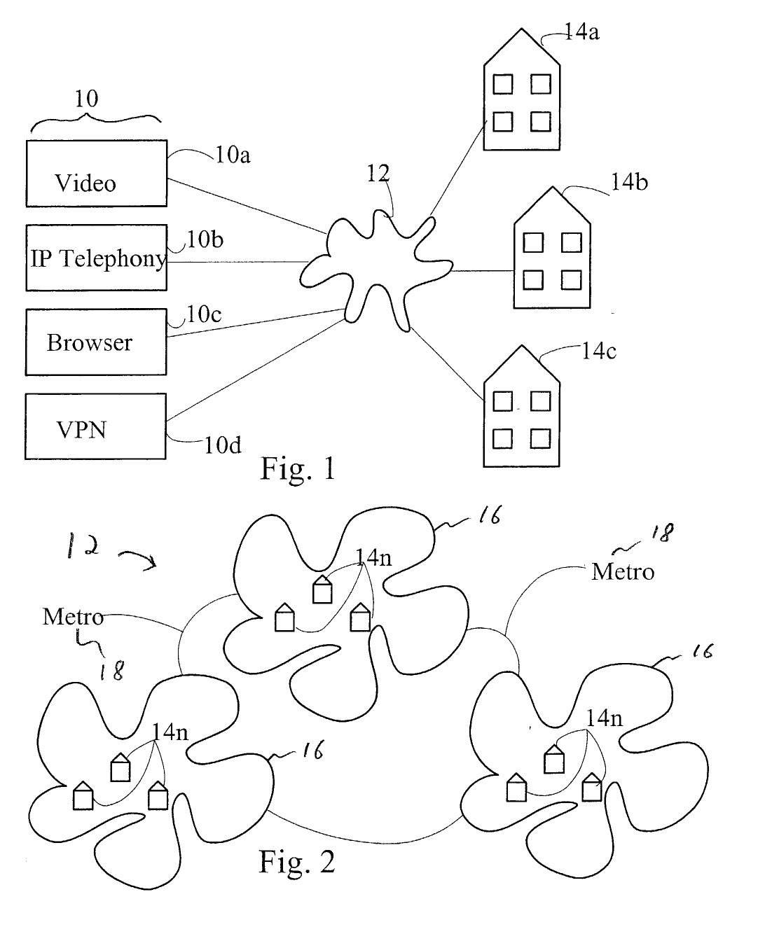

A hybrid fiber-coax network is employed for provisioning services to users. Services are provided through a service provisioning system via a network as described below. FIG. 1 shows a context diagram of the present invention. Referring to FIG. 1, a plurality of services 10 are available for provisioning to users 14a-14c via a network 12. The users 14a-14c are shown as exemplary. A plurality 14a-14n of users can be supported. The network 12 may include a public access network such as the Internet and other networks described further below. The services include video 10a, such as pay-per-view, video on demand, and digital cable; IP telephony 10b, such as voice-over-IP (VIP) and digital telephones; Internet access via a web browser 10c, and Virtual Private Networks (VPN) 10d. Other services can be similarly provisioned.

FIG. 2 shows the network 12 in more detail. Referring to FIG. 2, the network 12 includes a plurality of local broadband access networks (LBANs) 16, interconnected across a metro area network 18. Each of the LBANs 16 includes at least a portion of a hybrid fiber-coax (HFC) network connected to individual users 14n generally. The metro area network is typically a public access network such as the Internet, and may be connected to other metro area networks via a wide area network (WAN, not shown). As indicated above, the use of an LBAN 16 allows services to be provisioned (provided) directly to the end users 14n using existing coax cables comprising the coax part of the HFC network. The metro area network 18 provides a high bandwidth connection from the network 12 to the LBAN 16 via an optical or other node serving each LBAN 16. In a typical embodiment, services are provisioned from a service delivery center (not shown), operated by the service provider, via the LBAN 16 in conjunction with the network 12.

In a particular embodiment, the LBAN is a Narad Broadband Access Network (NBAN) provided by Narad Networks Inc., of Westford, Mass., assignee of the present application, and as described in copending U.S. patent application Ser. No. 09/952,482, filed Sep. 13, 2001, entitled “Network Architecture for Intelligent Network Elements,” (Attorney Docket No. 3070.1000-003), incorporated herein by reference. As disclosed above, each LBAN serves approximately 500-1000 homes from a high speed optical unit such as an optical network distribution switch, employing the LBAN for the “last mile” connection from the high-speed trunk provided by the optical unit to the user via the legacy coax network.

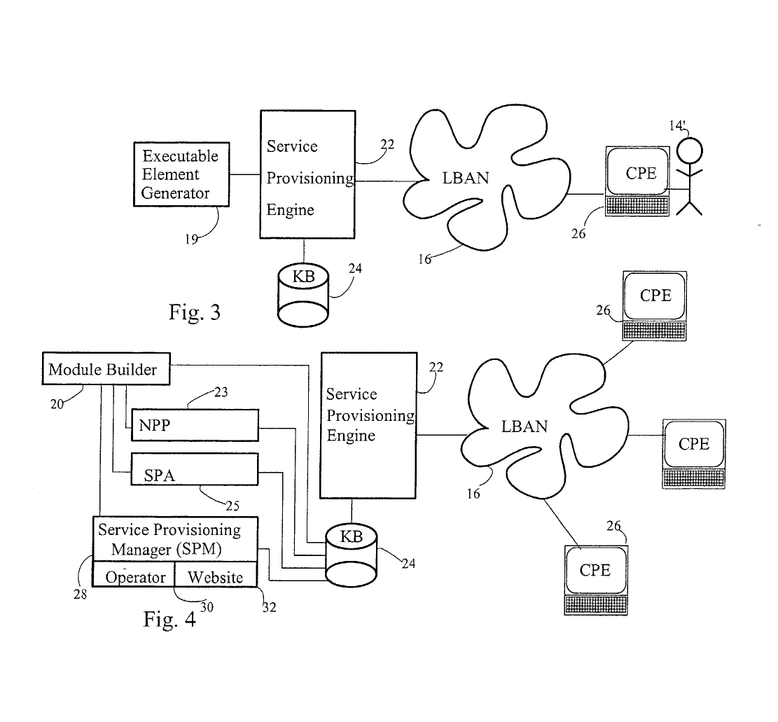

FIG. 3 shows a block diagram of the service provisioning system. Referring to FIG. 3, an executable element generator 20 is connected to a service provisioning engine 22. The executable element generator 20 generates executable scripts which are interpreted by the service provisioning engine 22. The executable element generator 20 is typically driven by a graphical user interface (GUI) invoked by a human operator. A knowledge base 24 stores the executable scripts and associated parameters. The service provisioning engine 22 is in communication with the LBAN 16, either directly or via other portions of the network 12 (FIG. 1), and provides the service via the LBAN 16. A user 14′ receives the service via one or more units of customer premises equipment (CPE) 26 also connected to the LBAN. CPEs 26 include PCs, telephones, TVs, and other devices adapted to be connected to the LBAN 16. The executable element generator 20 generates executable scripts directing the service provisioning engine 22 how to provide a particular service. In a particular embodiment, the executable scripts are XML compliant scripts. As described above, XML is a generic, platform independent syntax which may be interpreted by multiple platforms. The executable scripts as defined herein are therefore applicable to a plurality of platforms which recognize the XML language. In alternate embodiments, other script or language formats may be employed. The service provisioning engine 22 reads the executable scripts and may read associated executable scripts and parameters from the knowledge base 24. The service is then provisioned, or provided to the user, via the LBAN 16, typically by sending messages to the CPE 26 and other network elements concerned with providing the service.

FIG. 4 shows the service provisioning system of FIG. 3 in more detail. Before describing FIG. 4, some background on service provisioning may prove beneficial. Services are provided in the form of network transmissions and interactions which are selectively enabled for users who have subscribed to the service. The services as employed in the present system are an enumerated collection of network-based operations and/or transmissions initiated by a service provider, typically on a revenue-generating fee-for-services basis. An example is video-on demand transmitted from the service provider to the user's CPE 26. A service is typically, but not necessarily, associated with one or more provisioning objects for providing the service. A provisioning object may be, for example, a router operable to provide QOS based throughput sufficient for video-on-demand. Each provisioning object associated with a service has configuration parameters which are used to configure the provisioning object for providing the service according to the requirements of the service provider. Configuration parameters are directed to a particular hardware provisioning object for provisioning a particular service, such as assigning ports and buffers within a device.

Similarly, each service also has element parameters which direct the provisioning object in providing the service. The element parameters direct the provisioning object how to provide at least a portion of the service. For example, service parameters for a video-on-demand service may direct a router to deliver at a QOS level of guaranteed variable bit rate real-time.

Additionally, each service has one or more service plans. A service plan is an instantiation of a service offered by a particular service provider. For example, a video-on-demand service provider may have one service plan providing ten movies a month and another service plan providing twenty movies a month.

Referring to FIG. 4, the executable element generators include a module builder 20 for initially generating the executable scripts. The executable element generators, or script processors which consume the executable scripts and generate provisioning parameters include a network pre-provisioning (NPP) manager 23, a service plan administrator (SPA) 25, and a service provisioning manager 28 (SPM). The module builder 20 is a graphical user interface which generates executable scripts indicative of provisioning parameters for a particular provisioning object, such as network elements, services, and service plans. This tool allows a vendor to describe a provisioning object as it relates to the system in the syntax employed by the executable scripts. The module builder 20 can be employed, for example, by a vendor manufacturing hardware to be interconnected over the LBAN, such as a router manufacturer for routing video-on-demand or a laptop manufacturer on which the video-on-demand is to be received. The executable script is then stored in the knowledge base 24 along with an indicator so that it may be employed by the script processors to provide the service 10, (FIG. 1).

The NPP 23 manager allows a service provider to process executable scripts including defining configuration parameters corresponding to a particular network element. The configuration parameters allow the service provider to configure the network element provisioning object for a service, and would be invoked by the service provider, such as a network operator, to whom the network element was supplied. The NPP 23 receives an executable script generated by the module builder 20 for each network element concerned with providing the service. The NPP 23 then allows a network engineer at the service provider to configure the network element by defining the element parameters.

The SPA 25 allows a service provider to process executable scripts including element parameters corresponding to a particular service 10 (FIG. 1). The element parameters allow the service provider to direct the provisioning object how to perform the service, and would be invoked by the service provider to which the provisioning object was supplied. The SPA 25 receives an executable script generated by the module builder 20 for each provisioning object concerned with providing the service. The SPA 25 then allows a network engineer at the service provider to describe their service as it relates to a provisioning object in the syntax of the executable script. In the example above, the SPA 25 would be employed by the video-on-demand service provider to generate a script to direct the router and the laptop accordingly, for example to transmit and receive at a particular number of bits per second or frames per second. Other exemplary element parameters include maximum frame error rate, retry timeout and rate, port number (application type), and TCP/IP error recovery variables such as the slow start window and fast retransmit.

A service provisioning manager (SPM) 28 allows generation of an executable script defining a particular instantiation of a service (10, FIG. 2), or service plan, to be defined. Service parameters are defined within each of the service plans via the GUI of the SPM 28. The SPM defines an instantiation of the service in terms of service parameters, including variables specific to a particular user, such as price, duration, billing options, and others. In the above example, a particular service plan might specify that the video-on-demand service provides a movie for a 24 hour period, or, for example, a service plan applicable to subscribers in Westford, Mass. which encompasses knowledge of the local cable provider's coax network. The SPM 25, therefore, allows an operator to process executable scripts for specifying service parameters corresponding to each service plan.

The three types of script processors NPP 23, SPA 25, and SPM 28 each receive, or consume the executable scripts from the module builder. Each script processor processes the scripts to define provisioning parameters for a provisioning object. Each script processor is operable to receive service provisioning input from a particular type of client, and defines a particular type of provisioning parameters such that the service provisioning engine 22 may receive the provisioning parameters and direct the corresponding provisioning object accordingly. Specifically, the NPP 23 defines configuration parameters applicable to network elements, and would typically be invoked by a network operator (NOP) responsible for maintaining the network elements in running order. The SPA 25 defines element parameters applicable to services, and would be invoked by a service provider to set up a service. The SPM 28 defines service parameters applicable to a service plan, and would be invoked by a telephone operator or web interface responsive to an end user request for a specific service to be provisioned, described further below.

Each of the provisioning parameters from the executable scripts is written to the knowledge base 24 for later retrieval by the service provisioning engine 22. An indicator corresponding to the service and the service provider is also written so that the executable scripts may be indexed and retrieved. In a particular embodiment, the knowledge base is an LDAP directory.

The service provisioning manager 28 initiates provisioning of a service in response to a request from a user 14. By employing the executable script or scripts corresponding to a service 10 (FIG. 1), a user may select from among available service plans and relevant service parameters associated with the plan. The service provisioning manager 28 employs both an operator interface 30 and a web-based interface 32. The operator interface 30 is staffed by a human operator who initiates the service in response to a telephone call, email, hardcopy mail, or other indirect request, and is ideal for a user unfamiliar with GUIs. Such an interface may be employed at a service delivery center comprising the service provider's servers and equipment. The web-based interface 32 may be accessed directly by a user who enters information specifying the service plan and service parameters desired, along with other pertinent personal and billing information.

The service provisioning manager 28 then directs the service provisioning engine 22 to provide the service to the CPE 26 of the user via the LBAN 16. The service provisioning engine 22 retrieves the applicable provisioning parameters resulting from the processing of the executable scripts, including the service parameters, the element parameters, and the configuration parameters from the knowledge base 24. In this manner, a general purpose service provisioning system is established which can provision a plurality of services for a plurality of users across multiple platforms supporting XML compliant files by employing the executable element generator to generate executable scripts concerned with provisioning the services.

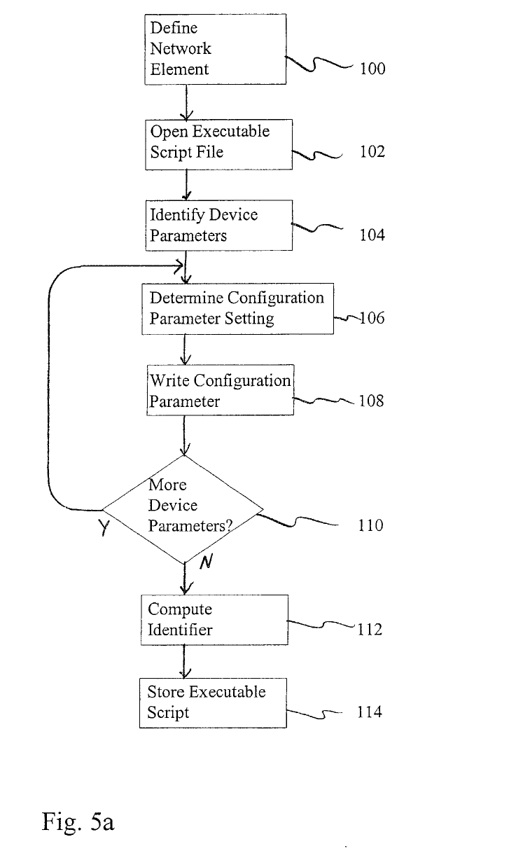

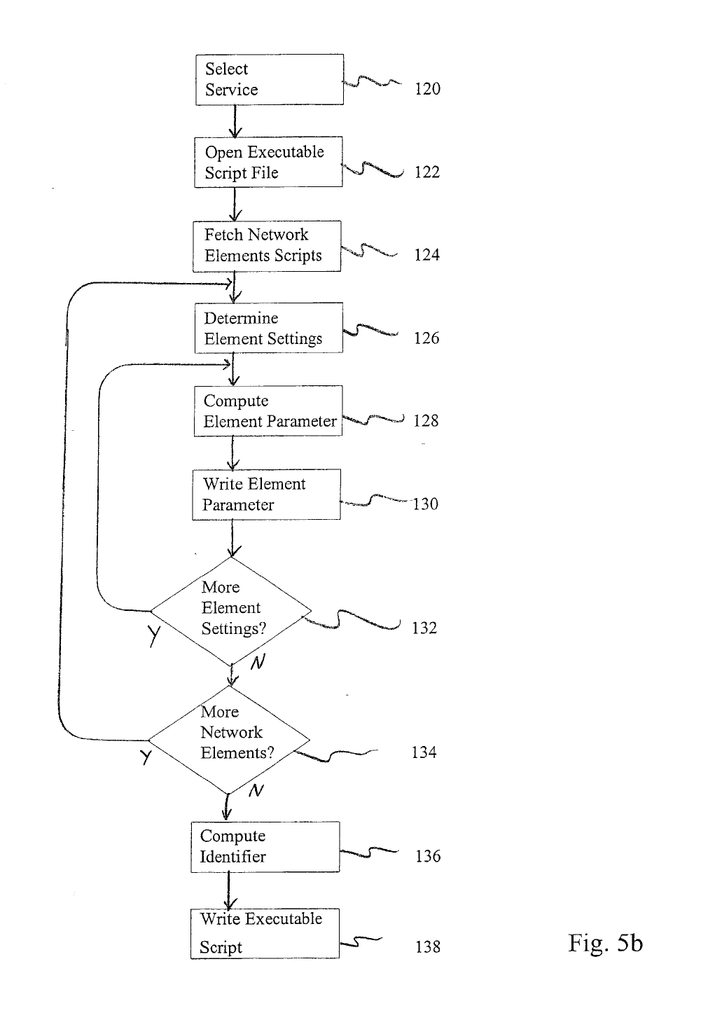

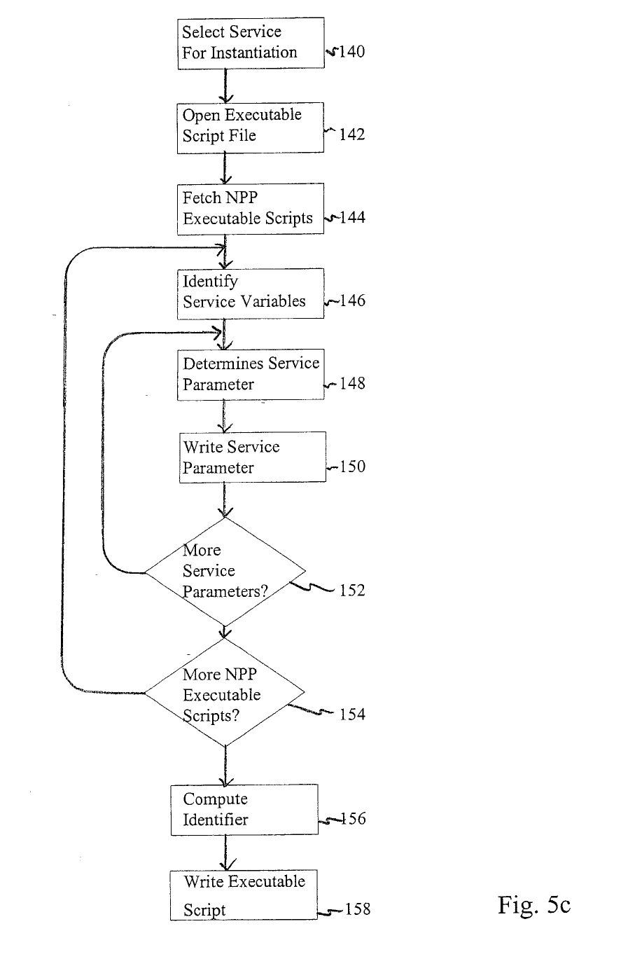

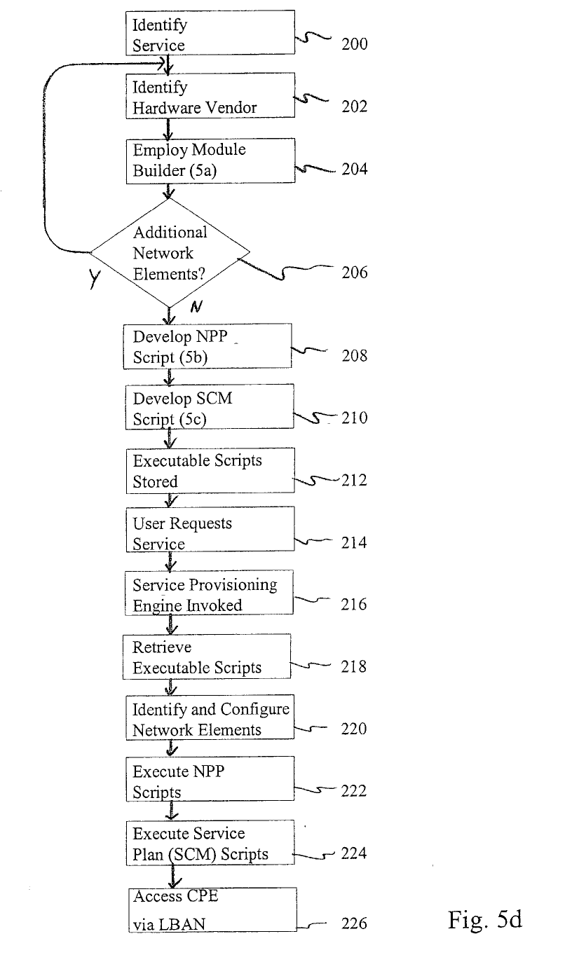

FIGS. 5a-5d show flowcharts of a particular embodiment of the service provisioning system. Referring to FIG. 5a, a flowchart of the operation of the module builder 20 is shown. A network element is defined which is to be employed in providing one or more services, as depicted at step 100. An executable script file corresponding to the network element is opened, as described at step 102. The device parameters or settings concerned with providing one or more services are identified, as shown at step 104. For each device parameter, the operator determines a configuration parameter setting or value for the device parameter, as depicted at step 106. An entry having the configuration parameter indicative of the determined parameter setting is written to the executable script, as disclosed at step 108. A check is performed to determine if there are more device parameters for this network element, as shown at step 110. If there are more device parameters, control reverts to step 106. If there are no more device parameters for this network element, an identifier for the executable script is computed, as disclosed at step 112. The executable script is then stored in the knowledge base 24 (FIG. 4) along with the identifier, as depicted at step 114.

FIG. 5b shows a flowchart of network pre-provisioning (NPP). Referring to FIG. 5b, a service is selected for pre-provisioning, as disclosed at step 120. An executable script file corresponding to the service is opened, as described at step 122. The executable script generated by the module builder for any network elements concerned with provisioning the service are fetched from the knowledge base (FIG. 4), as shown at step 124. For each network element concerned with provisioning the service, element settings for the network element are determined, as depicted at step 126. For each element setting, the operator determines the element parameter for the element setting, as depicted at step 128. An entry having the element parameter corresponding to the element setting is written to the executable script, as disclosed at step 130. A check is performed to determine if there are any more element settings for the current network element, as shown at step 132. If there are, control reverts to step 128. If there are no more element settings for the current network element, a check is performed to see if there are any more network elements concerned with provisioning this service, as depicted at step 134. If there are, control reverts to step 126, otherwise an identifier for the service and the corresponding executable script are computed, as disclosed at step 136. The executable script and the corresponding identifier are then written to the knowledge base, as shown at step 138.

FIG. 5c shows a flowchart of the service provisioning manager 28 (SPM). Referring to FIG. 5c, a service is selected for instantiation, as shown at step 140. An executable script file corresponding to this instantiation, or service plan, is opened, as depicted at step 142. Executable scripts created by the NPP module for this service are fetched from the knowledge base, as shown at step 144. For each NPP script associated with this service, service variables are identified, as shown at step 146. An operator determines the proper service parameter for this service variable depending on the service plan desired, as shown at step 148. An entry having the service parameter is written to the executable script, as depicted at step 150. Other service parameters not specific to the NPP executable script may be entered as well. A check is performed to determine if there are more service parameters corresponding to this NPP executable script, as disclosed at step 152. If there are, control reverts to step 148, otherwise a check is performed to determine if there are any more NPP executable scripts for this service plan, as shown at step 154. If there are more NPP executable scripts, then control reverts to step 146, otherwise, an identifier for this service plan is computed, as shown at step 156. The executable script and the identifier are then written to the knowledge base, as depicted at step 158.

FIG. 5d shows a flowchart of the service provisioning flow comprising the flow shown in FIGS. 5a-5c. Referring to FIG. 5d and FIG. 4, a service provider identifies a service 10 (FIG. 1) for provisioning via the LBAN 16, as depicted at step 200. A hardware vendor is identified to develop or provide a network element for providing the service, as shown at step 202. An executable script corresponding to the network element is developed by the vendor employing the module builder 20, including the sequence shown in FIG. 5a, as disclosed at step 204. A check is performed to determine if there are additional network elements concerned with providing the service, as shown at step 206. If there are additional network elements, control reverts to step 202. Otherwise an NPP 23 script corresponding to the service is developed, including the sequence shown in FIG. 5b, as disclosed at step 208. The service provisioning manager 28 is then invoked to develop an executable script corresponding to service plans corresponding to the service, as described in FIG. 5c and depicted at step 210. Executable scripts for providing an instantiation of the service are now stored in the knowledge base from each of steps 204, 208 and 210, as shown at step 212. A user requests an instantiation of the service by accessing the service provisioning manager 28, as disclosed at step 214. As indicated above, the service provisioning manager 28 may be accessed directly via the web or indirectly via a human operator at the service operations center. The service provisioning manager 28 receives the user request, and invokes the service provisioning engine 22 to provision the service, as depicted at step 216. The service provisioning engine 22 then retrieves the executable scripts corresponding to the service from the knowledge base, as shown at step 218. The network elements concerned with provisioning the service are then identified and configured by the service provisioning engine 22 by executing the executable scripts generated by the module builder 20, as described at step 220. If required, executable scripts concerning the service generated by the NPP are executed, as shown at step 222, to initialize the network elements. The executable scripts comprising the service plan are then executed to provision the service, as described at step 224. The LBAN is accessed to determine the CPE of the target user of the provisioned service, as disclosed at step 226, and the service provisioned by accessing the CPE at the user site. In this manner, services are scalably and dynamically provisioned for each user over the LBAN by employing the executable scripts concerned with providing the service.

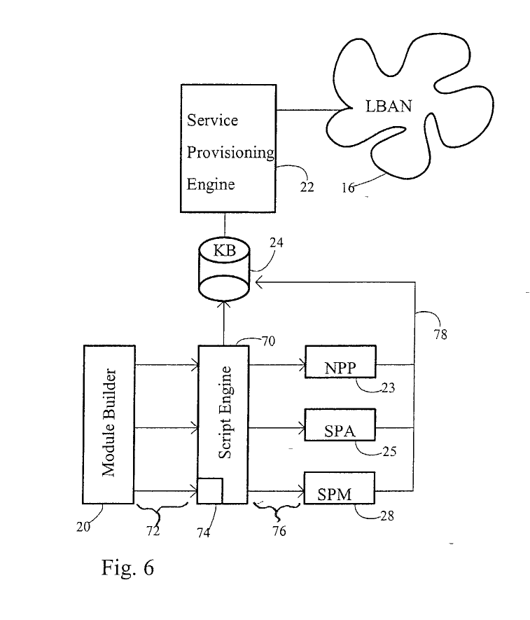

In another particular embodiment, shown in FIG. 6, a script engine 70 is employed between the module builder and the executable element generators. The script engine 70 is conversant in a service definition language common to the executable element generators and to the module builder, and generates module scripts 72 in the script definition language. The script definition language may be based on a known metalanguage such as XML to provide compatibility and facilitate external interfaces, described further below.

The module scripts employ the constructs of the script definition language. In a particular embodiment, the script definition language provides a hierarchical rule structure as described below with respect to the DTD in TABLE IV. The script definition language includes elements, behaviors, classes, flows, and tasks. A user interface (UI), which is typically a graphical user interface (GUI) is also employed to present and collect information from the user, such as an MSO (Multi-Service Operator).

A group of low-level programming elements is used to describe standard low-level programming concepts such as variable assignment, data structures, comparison, string concatenation, branching, looping, splits, joins, suspends, resumes, transaction demarcation, and error handling. The language includes support for arrays, keyed tables, and a wide variety of scalar types.

Using the behavior element, one can define the functionality of a network/service element and a service in the syntax of the language. Each behavior consists of zero or more properties and a set of actions. For example, an MSO can define the functionality of a VLAN switch to be employed by a service using this behavior construct. Further, the MSO can add actions to this behavior such as provisioning the VLAN as part of behavior definition.

Classes are used to model concrete network/service elements and the services entities like service plans, subscriptions, etc. Each class comprises of list of properties, actions and a list of behaviors that the class implements, and also specifies flow binding for each action. For example, using this class element, a switch vendor may model a particular switch to define its properties, actions and the behaviors. Once a behavior or behaviors are attached to a service element, the service element can be used as part of the MSO's service flows.

Though the language specification includes a broad set of core tasks to perform database operations, file manipulation, object manipulation and protocol signaling, it may also be employed to define a new set of tasks that can be used as part of the flows. Using the task construct, user can define an interface to access java task code. For example, using this task element, a network element vendor can develop a custom java task to provision a VLAN on their VLAN switch.

The XSML flow construct can be used for describing complex object oriented workflows with user interactions. The tasks, UI resources and low-level programming concepts are held together by a set of elements that define a sequence of states in a flow. Each state in a flow can: a) execute a task, behavioral action or another flow; b) present and collect information from the user; c) perform testing and branching based on evaluation of a conditional expression; and d) evaluate assignment variable expressions. These flows can be bound to the class actions or class behavioral actions so that when an action of a class or behavior is invoked, the corresponding bound flow is triggered and executed.

The module scripts 72 are invoked by the executable element generators 23, 25, and 28 to generate executable objects 78, which are adapted for operations similar to the executable scripts as described above. The executable element generators 23, 25, and 28 receive the module scripts 72 via a script engine 70. FIG. 6 shows a data flow of the script engine 70 and module scripts employed in creating and provisioning services. Referring to FIG. 6, the module builder 20 generates module scripts 72 corresponding to each of the network entities: elements, services, and subscriptions. Once generated by the module builder 20, the module scripts are stored in the knowledge base 24 for subsequent retrieval.

Each of the module scripts 72 is adapted to be processed by the script engine 70 according to a set of script rules 74, or document type definition (DTD), described further below. The scripts are processed by the script engine 70, and the processed script 76 is received by a respective one of the executable element generators 23, 25, or 28, depending on the network entity to which the script corresponds. Multiple module scripts may be received and processed by the executable element generators 23, 25, 28, and used to produce an executable object, shown by arrow 78, which is also stored in the knowledge base 24.

As indicated above, each of the three types of executable element generators 23, 25, and 28 receives a particular type of module script. The Network Pre-provisioning manager 23 (NPP) processes module scripts corresponding to network elements, generally hardware boxes such as switches and routers. The Service Plan Administrator 25 (SPA) processes module scripts corresponding to services to be offered, such as mobile phone and video-on-demand. The Service Provisioning Manager (SPM) 28 processes module scripts corresponding to subscriptions, which are instantiations of a service associated with a particular user, or subscriber, on a fee for services basis. The executable element generators 23, 25 and 28 gather values for predetermined attributes in the module script, typically via a graphical user interface (GUI). The executable element generators 23, 25 and 28 also identify and resolve interfaces specified in the module scripts between network entities.

Each of the executable element generators generates an executable object, which is directed to updating and maintaining the element, service, or subscription in the NSOS. Maintaining includes updating signaling stacks, topology information, adaptors, and other systems within the NSOS, shown further below with respect to FIG. 8. Accordingly, the executable element generators typically process multiple module scripts, as a service generally relies upon at least several network elements, each corresponding to a module script, and similarly, a subscription may reference multiple services. The executable objects are executed by the service provisioning engine 22, which interacts with the LBAN 16 to provision and deliver the service.

The module builder 20, therefore, generates module scripts 72 which may be stored and manipulated by the executable element generators in creation and management of a service. Since a module script is specific to a particular network entity, the network entities, such as elements, services, and subscriptions, concerned with providing a particular instance of a service to a user may be seamlessly and rapidly identified and provisioned appropriately to deliver the service to the user and bill the user accordingly. Further, in alternate embodiments, a module script 72 may be generated by an external entity rather than the module builder. This arrangement allows a third party vendor to supply a network entity and provide a manually built module script to allow integration with the NSOS framework described above.

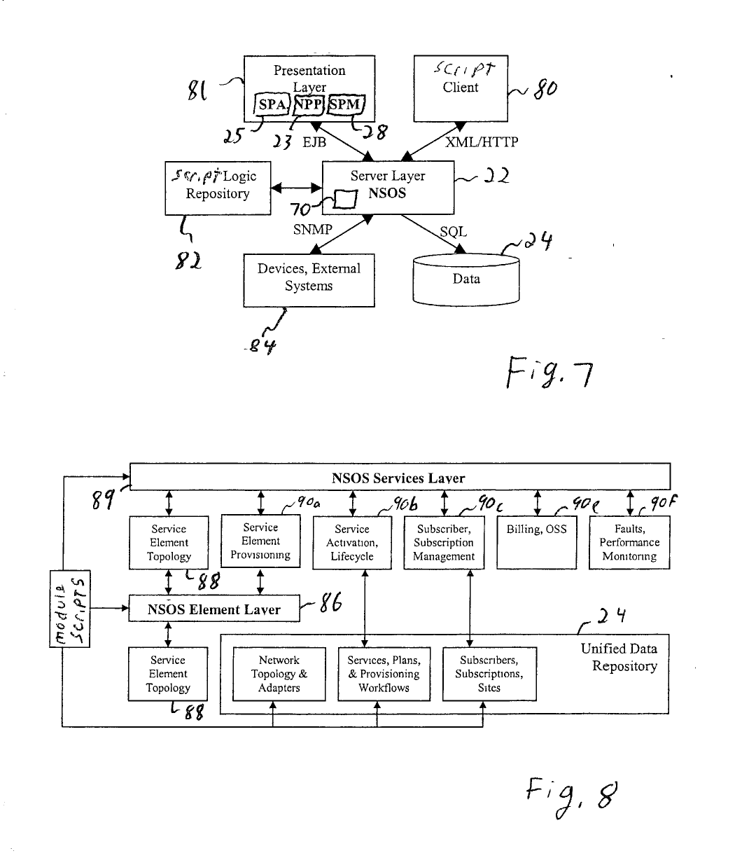

FIG. 7 shows a three tier model of a particular embodiment the architecture of the network services operating system (NSOS) as it employs the system disclosed herein. The presentation layer 81 includes the executable element generators 23, 25, and 28, and communicates with the server layer via an enterprise javebeans (EJB) interface. The server layer represents the service provisioning engine 22 executing the NSOS kernel and the script engine 70. The service provisioning engine 22 is also in communication with a script logic repository 82, including service and element specific instructions referenced in the module scripts. An HTTP (HTML—Hypertext Markup Language) interface allows communication with web-based clients 80 via the module scripts or HTTP. An SNMP (Simple Network Management Protocol) interface facilitates network interconnections to network entities (devices) and external system 84. The knowledge base 24 provides a repository for the module scripts 72, executable objects 78, and associated systems, described below.

FIG. 8 shows different layers and systems within the NSOS responsive to the module scripts 72 similar to FIG. 7. The knowledge base 24 contains the unified knowledge repository. The element layer 86 concerns network elements, such as switches and routers, particularly with regard to topology 88. The services layer 89 is concerned with the service provided by the elements, and includes the systems 90a-90f as shown.

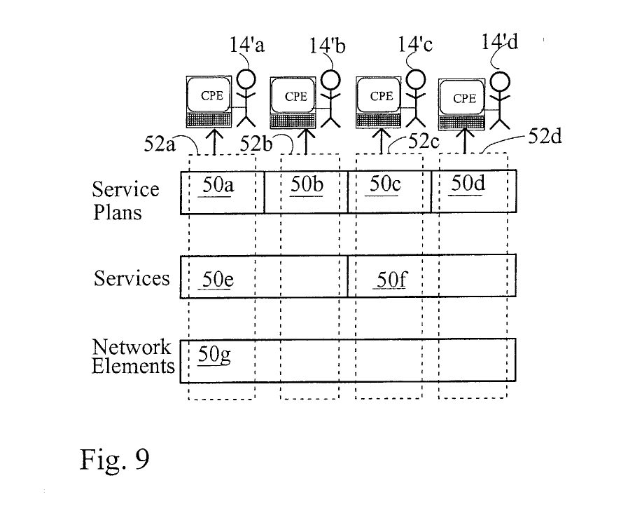

FIG. 9 shows the multiple executable scripts invoked in provisioning a particular service plan. As indicated above, each of the executable element generators generates a particular type of executable script. In the examples given, the executable scripts are directed to network elements, services, and service plans. Multiple executable scripts may be invoked for provisioning a particular service, for example the same router, a network element, may be invoked to deliver services to multiple users. Accordingly, the same executable script may be invoked for a plurality of service instantiations. Referring to FIG. 9, a plurality of users 14a′-14d′ are each being provisioned. Each of users 14a′-14d′ is being provisioned for a service which invokes executable scripts as indicated by the dotted lines 52a-52d, respectively. User 14a′ is provisioned for a service which invokes executable script 50a for a service plan, executable script 50c for the service, and executable script 50g for a network element, as shown by the dotted line 52a. Similarly, user 14b′ is provisioned for service plan denoted by executable script 50b, but for the same service and hence employing executable scripts 50e and 50g as well. User 14c′ is provisioned using executable scripts 50c, 50f, and 50g, and user 14d′ is provisioned using executable scripts 50d, 50f, and 50g, as indicated by dotted lines 52c and 52d, respectively.

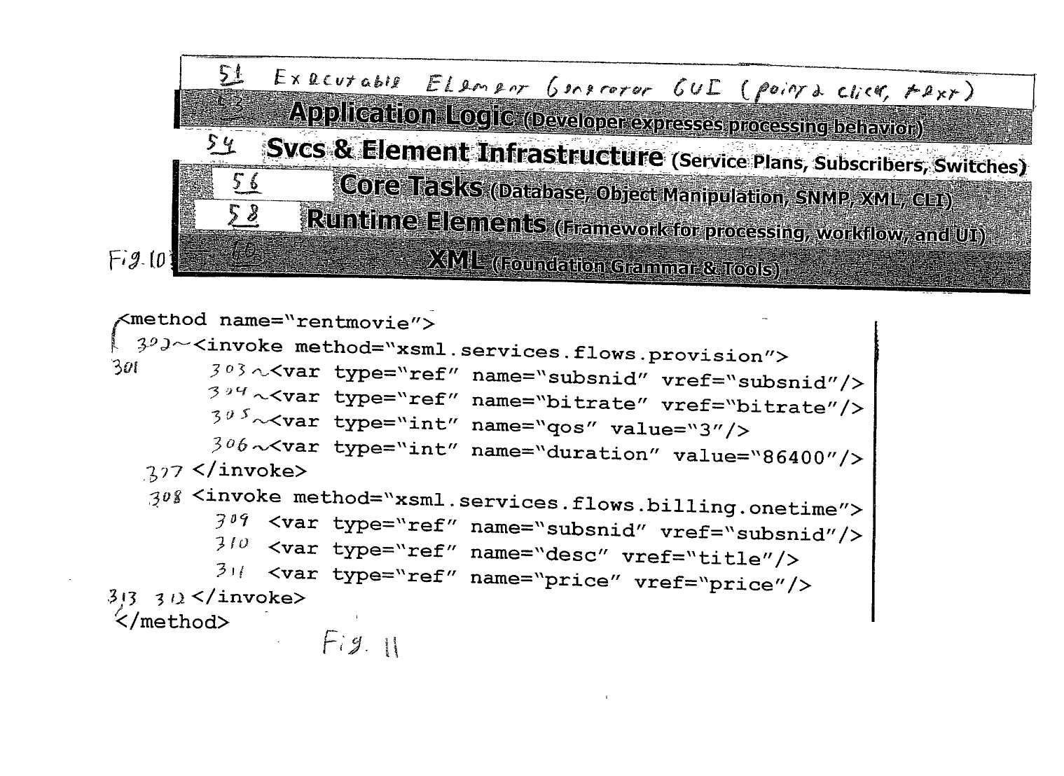

FIG. 10 shows a layer diagram of the execution environment employed by the present invention. Referring to FIG. 10, a top layer 51 includes the GUI presentations and input requests, including point-and-click inputs and free-form text entries. A human operator invoking the executable element generator 20 (FIG. 4) supplies inputs to the GUI depending on the service and the desired executable script. A second layer 53 contains the application logic. This layer drives the GUI to conditionally request input from the GUI which ensures that all required input needed to generate the desired executable script is entered. A third layer 54 includes the services and element infrastructure. This layer 54 includes data and processing concerned with specific network elements, services, and service plans to enable access to particular entities, such as to the knowledge base 24 (FIG. 4) using the identifier. A core tasks layer 56 allows knowledge base and object manipulation, such as storing and fetching from the knowledge base 24 based on the identifier. A runtime elements layer 58 coordinates runtime tasks and objects, such as initiating and terminating runtime objects, coordinating message passing and semaphores between objects, and generally providing the runtime environment for generating the executable scripts. A base layer 60 includes the underlying XML grammar, syntax and logic rules to which the executable entity is conformant. Since XML is recognized by a plurality of platforms, it is a common denominator by which the executable entities are related, such that the service provisioning as described herein is implemented in a platform independent manner.

FIG. 11 shows an example of a module script to be executed by the service provisioning engine 22 (FIG. 4). Referring to FIG. 8, a module script processed by the SPM and corresponding to a service plan for the video-on-demand example above is shown. The module script identifies the service as “rentmovie,” corresponding to the video-on-demand service described above at line 301. A service provisioning operation is specified at line 302. Line 303 identifies the particular SUBScriber Network Identifier (SUBSNID) identifies the user and associated CPE. Line 304 specifies the bit rate for this transmission to be sufficient for real time video. Line 305 indicates that the QOS is QOS level 3, which corresponds to, for example, VBR-RT (variable bit rate real-time) for supporting video. Line 306 specifies the duration that the bit rate is to be supported. The syntax paragraph is terminated at line 307, and a billing paragraph begins, as shown by line 308. This transaction is identified as a one-time transaction, such as a pay-per-view instance. The subscriber is again identified at line 309, and the title and price of the movie identified at lines 310 and 311, respectively. The paragraph is terminated at line 312, and the executable script terminated at line 313. Note that this example is intended as illustrative, and that many module scripts, each processed by different executable element generators, are likely to be invoked in the provisioning of a particular service.

The module scripts are each directed at a corresponding executable element generator 23, 25, and 28 as described above. Tables I-III show code fragments corresponding to each of the types of module scripts NPP 23, SPA 25, and SPM 38, respectively, processed by the corresponding executable element generators. Further, the script rules of the script definition language, also called a DTD, are shown in Table IV.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

Those skilled in the art should readily appreciate that the applications and programs for module script processing as defined herein are deliverable to a computer in many forms, including but not limited to a) information permanently stored on non-writeable storage media such as ROM devices, b) information alterably stored on writeable storage media such as floppy disks, magnetic tapes, CDs, RAM devices, and other magnetic and optical media, or c) information conveyed to a computer through communication media, for example using baseband signaling or broadband signaling techniques, as in an electronic network such as the Internet or telephone modem lines. The operations and methods may be implemented in a software entity executable by a processor or as a set of instructions embedded in a carrier wave. Alternatively, the operations and methods may be embodied in whole or in part using hardware components, such as Application Specific Integrated Circuits (ASICs), state machines, controllers or other hardware components or devices, or a combination of hardware, software, and firmware components.

While this invention has been particularly shown and described with references to preferred embodiments thereof, it will be understood by those skilled in the art that various changes in form and details may be made therein without departing from the scope of the invention encompassed by the appended claims. Accordingly, the present invention is not intended to be limited except by the following claims.

What is claimed is:

1. A services definition language, comprising:
a predefined set of attributes, each of the attributes applicable to at least one network entity, the attributes operable to be selectively identified by an operator interface to correspond to a particular network entity;
a plurality of elements, each of the elements adapted to include at least one attribute; and
a hierarchical rule structure indicative of the arrangement of elements; the attributes adapted to receive values corresponding to the operation of the network entity.

2. The language of claim 1 wherein the operator interface is a module builder.

3. The language of claim 1 wherein the hierarchical rule structure is a Document Type Definition (DTD).

4. The language of claim 1 further comprising tags, each tag including at least one attribute and at least one value.

5. The language of claim 1 wherein the language is further adapted to be processed by a metalanguage processer, the metalanguage processor conforming to the hierarchical rule structure.

6. A language for defining and deploying services comprising:
a plurality of elements, each of the elements operable for performing a predetermined action;
a plurality of behaviors, each of the behaviors having a set of actions and at least zero attributes;
at least one class, each of the classes including at least one behavior and corresponding to a service entity; and
at least one task, each of the tasks adapted to execute a behavior.

7. The language of claim 6 further comprising a flow, the flow having a plurality of states, each of the states operable to execute behaviors, tasks, and other flows.

8. The language of claim 6 wherein the elements further comprise low-level programming constructs.

9. The language of claim 6 wherein the behaviors are operable to define the functionality of a service entity.

10. The language of claim 6 wherein the classes are operable to model a particular service entity for providing a particular service.

11. The language of claim 6 wherein the tasks are operable to be executed concurrently.

12. A computer program product having computer program code for providing services via a services operating system comprising:
computer program code for providing a module builder operable to generate module scripts, the module scripts indicative of a service entity;
computer program code for providing a script engine, the script engine operable to process the module scripts to identify attributes of the corresponding service entity;
computer program code for providing at least one executable element generator, the executable element generator responsive to the script engine;
computer program code for generating, via the executable element generator, executable objects corresponding to the service entity by assigning values to the attributes;
computer program code for storing the executable objects in a knowledge base; and
computer program code for deploying the executable objects for providing services.
